(19) United States
(12) Patent Application Publication
(10) Pub. No.: US 2005/0278753 A1
(43) Pub. Date: Dec. 15, 2005

(54) Broadcast passenger flight information system and method for using the same

(75) Inventors: Kenneth A. Brady JR., Trabuco Canyon, CA (US); Lyle K. Norton, Irvine, CA (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/057,662

(22) Filed: Feb. 14, 2005

Related U.S. Application Data
(60) Provisional application No. 60/545,125, filed on Feb. 17, 2004.
(60) Provisional application No. 60/545,062, filed on Feb. 17, 2004.

(51) Int. Cl. H04N 7/18

(52) U.S. Cl. 725/76; 725/77

(57) ABSTRACT

A system and method for integrating a landscape image taken by a camera positioned in a vehicle, such as an aircraft, with images that are generated by an in-flight entertainment system (IFES) so that the IFES is capable of generating landscape images for the passengers while the aircraft is in flight. The IFES receives input data pertaining to characteristics of the aircraft and controls the display units that can be viewed by the passengers to generate a display image including information based on the input data and landscape video data provided by a camera positioned to obtain images from outside the aircraft, so that the passenger can view the landscape image along with information pertaining to the location of the aircraft, points of interest on the landscape image, and so on while the aircraft is in flight. The landscape image can be a real-time image or a frame image taken at periodic intervals. The information can also include a link to a web site that enables the passenger to click on the link to cause the display unit to display information pertaining to a point of interest in a browser-type display window.

### CROSS-REFERENCE TO RELATED PATENT APPLICATIONS

This application claims benefit under 35 U.S.C. § 119(e) from U.S. Provisional Patent Application No. 60/545,125, filed Feb. 17, 2004, and from U.S. Provisional Patent Application No. 60/545,062, filed Feb. 17, 2004, the entire content of each being incorporated herein by reference.

### BACKGROUND OF THE INVENTION

1. Field of the Invention

The present invention relates to an improved passenger flight information system (PFIS) and a method for using the same. More particularly, the present invention relates to a PFIS that is capable of providing passengers with enhanced audiovisual information such as general aircraft information, flight status information and various forms of entertainment, as well as enhanced landscape images including information pertaining to points of interest along the flight path, thus making the in-flight experience more enjoyable to the passengers.

2. Description of the Related Art

Many vehicles today, in particular, aircraft, include in-flight entertainment systems (IFES) or passenger information systems with which the passengers can interact via control device, such as control buttons on the armrests of the seats or other plug-in devices. More sophisticated IFES are being developed and employed on aircraft to further enhance the passengers' flight experience.

Typically, an IFES includes a plurality of computers, which are connected to provide various functions. These computers include, for example, audio/video head-end equipment, area distribution boxes, passenger service systems (PSS), and seat electronic boxes. In the modular environment of an aircraft, each of these computers is referred to as a line replaceable unit (“LRU”) since most are “line fit” on an assembly line when an aircraft is built and tested. At least some of the LRUs are connected directly to passenger seats, either individually or by seat groups. These LRUs are the interface between passengers on an aircraft and the IFES, and provide access to a plurality of functions. A more sophisticated, multi-functional IFES may include close to a thousand separate connected computers working together to perform the plurality of functions of the IFES.

The LRUs within a conventional IFES typically include relatively simple electronics and microprocessors for performing system functions. The channel and volume of the audio provided to a seat are conventionally controlled by a seat electronics box serving a group of seats, the seat electronics box including a microprocessor and signal conditioning electronics to handle audio/video input signal. In some known systems, the seat electronics box can be overridden by the cabin announcement system to allow for flight crew to interrupt audio or video with safety announcements for the passengers. IFESs must meet strict requirements set by the Federal Aviation Administration (FAA) for avoiding interference with safety critical flight electronics in the cockpit and elsewhere on board. In addition, the aircraft industry has set strict requirements on IFESs, for example, on the power use, bandwidth, and weight of an IFES. An IFES provider is severely restricted in choosing particular hardware and software components for these reasons.

Although existing IFESs are suitable for providing passengers with entertainment such as movies, music, news and other information, a need exists to improve IFESs to provide additional features to passengers which can make the passengers' flights even more enjoyable. Hence, in the airline industry where all carriers are competing to provide the best service at the lowest cost, the qualities of an airline's IFES may result in passengers choosing that particular airline over another.

### SUMMARY OF THE INVENTION

The embodiments of the present invention described herein integrate a landscape image, such as a moving or still JPEG image, taken by a camera positioned in a vehicle, such as an aircraft, with information generated by an in-flight entertainment system (IFES), so that the IFES is capable of generating mapped landscape images for the passengers while the aircraft is in flight. The IFES receives input data pertaining to characteristics of the aircraft, such as aircraft altitude, position, attitude, speed and so on, and controls the display units that can be viewed by the passengers to generate a display image including information based on the input data and landscape video data provided by a camera positioned to obtain images from outside the aircraft, so that the passenger can view the landscape image along with information pertaining to the location of the aircraft, points of interest on the landscape image, and so on while the aircraft is in flight. The landscape image can be a real-time image or a frame image taken at periodic intervals. The information can also include a link, such as hyperlinks or URLs, to web sites stored in the IFES or to web sites provided from outside the aircraft, such as via broadband terrestrial or satellite-based Internet access. The passengers can thus click on the links to cause the IFES to provide the linked information to the display unit, which thus displays the information pertaining to a point of interest in a browser-type display window. This information can include, for example, historical or other factual information regarding the point of interest, or any other type of information that may be useful or enjoyable to the passengers.

The embodiments of the present invention described herein further provide an image display system, adapted for use with an in-flight entertainment system (IFES). The image display system comprises a video display that receives video data provided by a camera positioned to obtain images from outside the vehicle, and that further receives information data from the IFES so that the video display can display an image including the video data and the information data on the displayed image. Specifically, the video display can display the video data image as a map having the information data represented as indicia on the map. The image can be static that updates at periodic intervals, or can be a continuous movie-type image, and can be any desired format (e.g., JPEG). The indicia is presented as sets of respective indicia at respective locations on the map proximate to respective images on the map relating to the information represented by the respective sets of indicia. Some of the respective indicia includes a link to additional information stored at a location other than the video display. The other location is a storage location in the IFES or a storage location remote from the vehicle, such that the additional information is provided to the video display via a wireless communication link. The image display system further includes an interactive device to enable a user to interact with the video display to allow the user to control the image being displayed by the video display. The interactive device enables the user to cause the video display to change the magnitude of the image being displayed. Specifically, the interactive device enables a user to interact with the video display to allow the user to select the link to cause the video display to display the additional information. The video display can retrieve the additional information via an Internet based device remote from the vehicle.

### BRIEF DESCRIPTION OF THE DRAWINGS

The above objects and advantages of the present invention will become more apparent by describing in detail a preferred embodiment thereof with reference to the attached drawings in which:

FIG. 1a is a schematic diagram of an example of a seat-level layout employing an in-flight entertainment system according to an embodiment of the present invention;

FIG. 1b is a schematic diagram of another example of a seat-level layout employing an in-flight entertainment system according to an embodiment of the present invention;

FIG. 2a is a block diagram of the hardware components used in a first part of an in-flight entertainment system, which includes head-end components, as used in accordance with an embodiment of the present invention;

FIG. 2b is a block diagram of the hardware components used in a second part of an in-flight entertainment system, including seat-level client components, as used in accordance with an embodiment of the present invention;

FIG. 2c is a block diagram of the software components used in a network protocol enabled in-flight entertainment system, as used in accordance with an embodiment of the present invention; and

FIG. 3 is an example of a screen view that can be generated on the display of the in-flight entertainment system shown in FIGS. 1a-2c, that includes the landscape image taken by the cameras and well as the information and URLs or links generated by the in-flight entertainment system that are superimposed over the image.

### DETAILED DESCRIPTION OF THE PREFERRED EMBODIMENTS

The following describes the infrastructure of an in-flight entertainment system employing enhanced video technology in which images, such as digital video or still images (e.g., JPEG), are taken by one or more cameras mounted the aircraft, and information indicia, such as current aircraft altitude, position, attitude and speed, and location points of interest, as well as links or URLs pertaining to those points of interest or aircraft information, are superimposed or otherwise overlayed on the images to present a still or moving map image of the landscape to passengers to essentially make every seat a window seat, and thus enhance the passengers' overall flight experience.

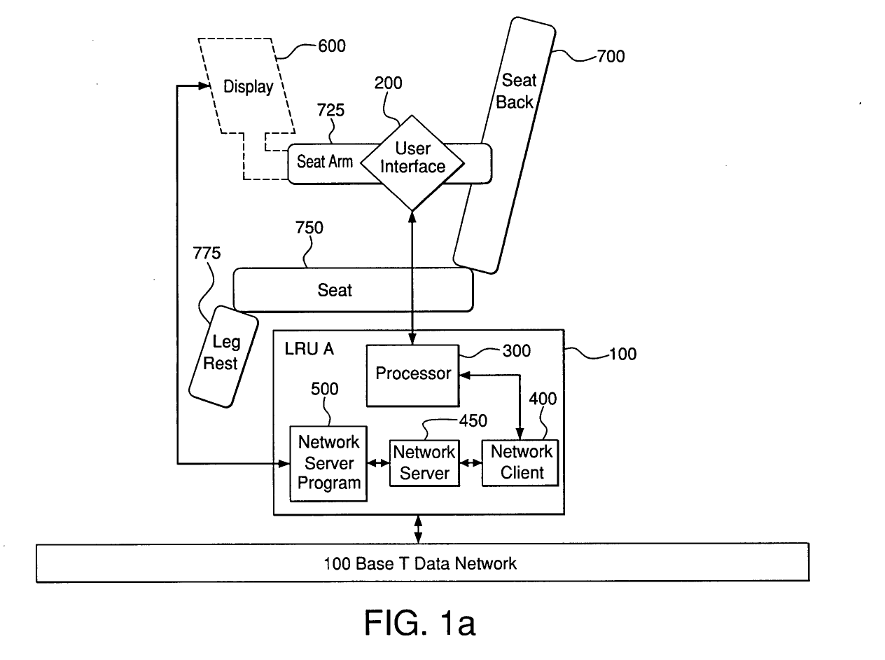

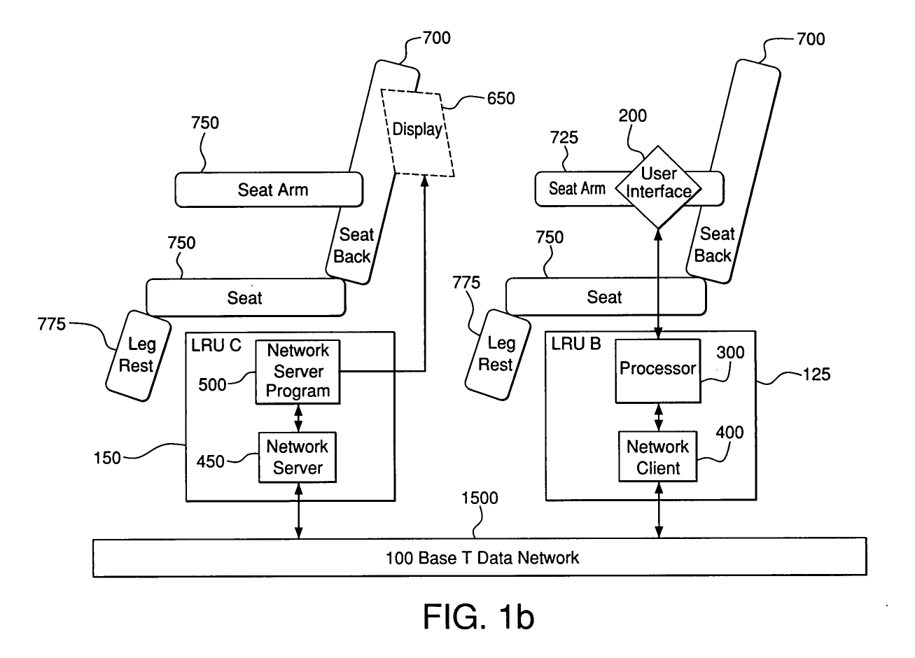

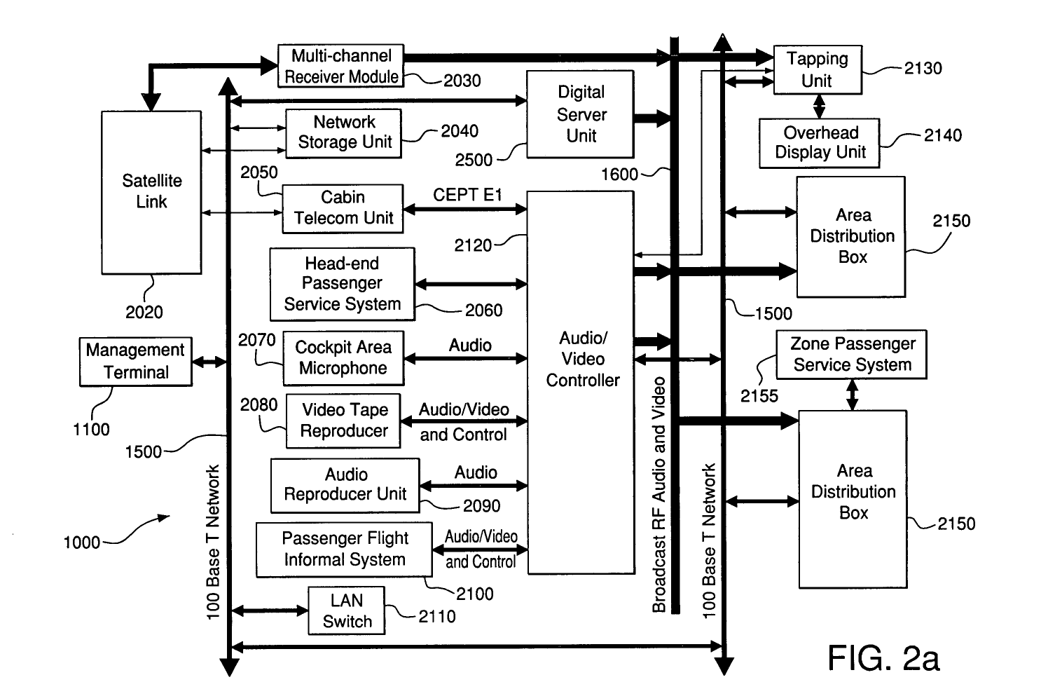

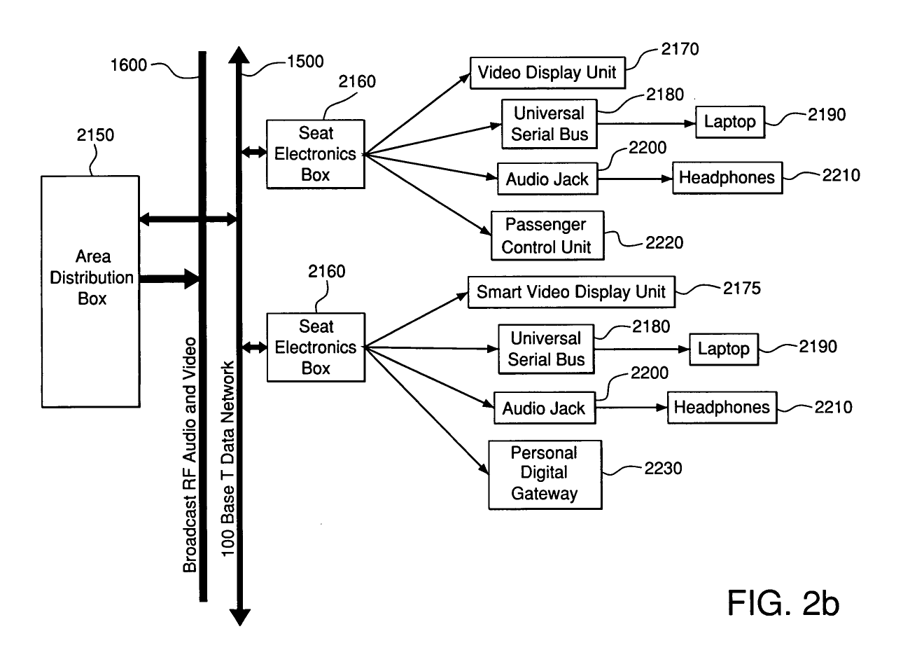

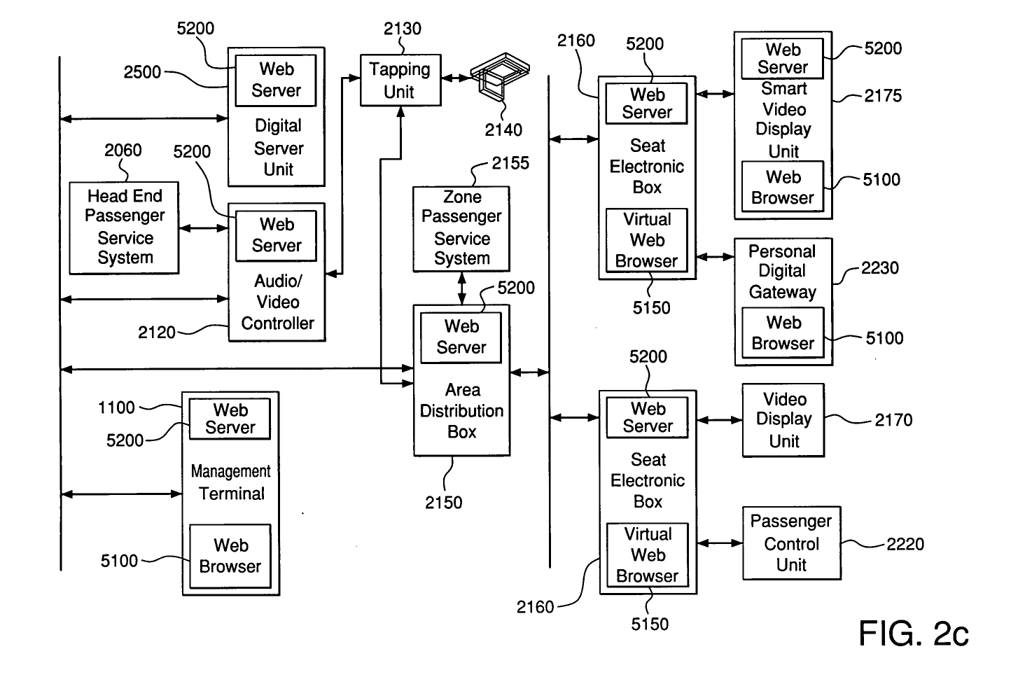

FIG. 1a illustrates an example of a seat arrangement employing an in-flight entertainment system (IFES) employing features according to embodiments of the present invention to make these image mapping features possible. As illustrated, the seat arrangement includes a seat 750, with a seat back 700, seat arm 725, and leg rest 775. Connected to the seat is a user interface 200, which can be any device suitable for providing input signal to the system, such as a set of membrane buttons, or a touch-screen. The user interface 200 is connected to a processor 300 within the LRU A 100. The LRU A is, in an embodiment, a seat electronics box 2160 (as shown and described in connection with FIG. 2b below). The processor 300 located within the LRU A 100 is a processor suitable for converting an input signal from the user interface 200 into a control activation signal that may be supplied to a network client 400. The processor 300 includes, in an embodiment, both hardware and software effective for converting the analog or digital input signal provided by the user interface 200 into the control activation signal supplied to the network client 400; the software includes, in an embodiment, a key routing table for mapping a particular input signal generated by the user interface 200 into a particular control activation signal.

In one arrangement, the network client 400 and the network server 450 are located on the same LRU (LRU A 100 in the embodiment of the seat-level part of the IFES shown in FIG. 1a). The network client 400 and the network server 450 may be located on the same LRU, since this improves the speed with which some functions of the IFES are executed. However, as will be shown in FIG. 1b, it is not necessary that the network client 400 and the network server 450 be located on the same LRU.

Communication between the network client 400 and the network server 450 is carried out using network protocols, such as HTTP, FTP, or TELNET. In the presently preferred embodiment of the invention, the protocol used is HTTP. In this embodiment, the network client 400 is a web browser, implemented with a suitable programming language, such as C++, on an operating system compatible with the hardware on the LRU A 100, such as LINUX. The control activation signal supplied to the web browser results in a URL call to a network server 450, which, in an embodiment, is a web server, such as the APACHE TOMCAT web server. The network server program 500 is, for example, a CGI script loaded into memory on the hardware of an LRU A 100. The network server program 500 has control over the hardware resources of the IFES 1000 that are necessary for performing a function of the IFES 1000 associated with the LRU on which the network server program 500 is loaded. For example, if the function to be controlled is associated with an overhead reading light, then the network server program 500 is connected to a switch within an electronic circuit that controls the overhead light, and is capable of opening and closing the switch by executing instructions on the hardware of the LRU connected to the electronic circuit (which, in the embodiment of the present invention shown in FIG. 2c, is the area distribution box 2150). If the function to be controlled is associated with in-seat audio and video display, then the LRU running the network server program 500 might be a digital server unit 2500 or an audio/video controller 2120.

As shown in FIG. 1a, the network server program 500 is connected to an optional display 600. The display 600 might include both audio and video capabilities (audio capability might be provided through headphones 2210 in FIG. 2b, described below). The network server program 500 executes instructions in order to control a function of the IFES. The network server program 500 thus may act to coordinate the hardware components within the IFES 1000 in controlling a complex function. Many network server programs 500 may run simultaneously on the same network server 450, and on different network servers 450. Several network clients 400 might request the same network server program 500 simultaneously, and the function performed by the network server program 500 can be performed at the request of several different users at the same time. A limit to the number of simultaneous requests is partly set by the network server 450 software (in one example, the APACHE TOMCAT software running on the LINUX operating system) that serves as the platform for the network server program 500, and partly by the hardware resources of the LRU on which the network server program 500 is run.

The network server 450 and the network server program 500 may be run on any LRU (with capable hardware resources) within the IFES. This allows for hardware resources to be conserved or distributed in a way that improves the efficiency of the overall IFES 1000. The system is very flexible and modular, and parts of the system may be moved around to different LRUs in different embodiments. This is possible since the connectivity of the parts of the system stays relatively constant when network protocols are used for communication between LRUs within the system.

In the arrangement of the seat-level part of the system shown in FIG. 1b, the network client 400 and the network server 450 are located on different LRUs within the system (LRU B 125 and LRU C 150). The network client 400 and the network server 450 communicate through the data network 1500, which can be a 100 Base T Ethernet data network 1500 which is shown in FIGS. 2a and 2b and described below. The separation of the network client 400 and the network server 450 gives rise to a slightly longer time lapse (between when an input signal is provided through the user interface 200 and when a function of the IFES is performed), but the separation allows for a greater flexibility and modularity of the IFES in that the network server 450 may be loaded on only a few of the LRUs within the IFES rather than on every LRU that might receive a request from a user that a particular function be performed.

The optional display 650 shown in FIG. 1b need not be connected directly to the seat with the user interface 200 (as in the embodiment of FIG. 1a). The display 650 can be connected instead to the seat back 700 of the seat in front of the seat with the user interface 200, and the difference in location of some parts of the system has no effect on the method of the present invention.

A block diagram of the hardware components of an entire IFES 1000 employing features according to embodiments of the present invention are shown in FIGS. 2a and 2b. Most of the boxes in FIGS. 2a and 2b represent a single electronic component, known in the art as a line replaceable unit (LRU), since these components are fitted onto an aircraft in an assembly line when the aircraft is manufactured, and can be replaced during maintenance in a similar manner.

The system 1000 is generally a local area network (LAN) comprising a plurality of computer components that communicate over a network data backbone 1500 and an entertainment broadcast or RF backbone 1600. The network data backbone 1500 preferably uses 100 base T Ethernet, and the broadcast RF backbone 1600 is preferably capable of carrying high-bandwidth RF transmissions containing video and audio signals.

Generally, the LRUs within the system 1000 include a management terminal 1100, an audio/video controller 2120, a digital server unit 2500, one or more area distribution boxes 2150 and a plurality of tapping units 2130 in communication over the data backbone 1500. Any of these LRUs may have hardware capable of running a network client 400, a network server 450, or both. The audio/video controller 2120, digital server unit 2500, and other auxiliary devices can provide audio and video signals over the RF broadcast backbone 1600 to the area distribution boxes 2150 or tapping units 2130. The area distribution box 2150 passes the signal to one or more seat electronics boxes (2160 in FIG. 2b) within its associated area. Alternatively, the tapping unit 2130 receives the signal from the broadcast backbone 1600 and sends the signal to one or more associated overhead display units 2140.

Management Terminal

As shown in FIG. 2a, the cabin management terminal 1100 can be a central user interface to the IFES 1000 for flight crew members. Using a management terminal 1100 as a user interface 200, a crew member might start and stop an in-flight movie, make announcements to passengers, or check food and drink orders. The management terminal 1100 also allows a user to enable or disable the availability of audio/video content or the Internet to passengers on the plane, or to enable or disable other functions of the IFES 1000 available to passengers through a user interface 200. Most functions of the IFES, whether initiated by a crew member or by a passenger, are controlled by a separate network server program 500 dedicated to controlling a particular function of the IFES 1000. As described above, the network server program 500 need not be located on an LRU nearby a physical location at which an input signal is generated. The management terminal 1100 might run only a network client 400 (as LRU B 125 shown in FIG. 1b), receiving a network server response from a network server program 500 on a different LRU within the IFES 1000. In another arrangement, the management terminal 1100 may have both a network server 450 (capable of running a network server program 500) and a network client 400. One such embodiment is shown in FIG. 2c, in which the management terminal 1100 is shown running both a web server 5200 and a web browser 5100.

A network server program, such as a CGI script, running on a network server on the management terminal is capable of controlling a function associated with an audio or video radio-frequency broadcast to passengers on the aircraft, an in-seat audio or video stream, interactive game playing, access to the Internet, an overhead reading light, a flight-attendant call system (including, for example, a display of passenger requests by seat), a climate adjustment system (including, for example, a thermostat connected to an air-conditioner), a surveillance system (including, for example, one or more security cameras and one or more displays attached thereto), a cabin audio or video announcement system, or a display (audio, video, or both) of passenger flight information as discussed in more detail below.

The management terminal 1100 is connected, in an embodiment, to a 100 Base T Ethernet data network (heretofore “Ethernet”) 1500. The local area network (LAN) switch 2110 in FIG. 2a is an important feature of the IFES 1000. The LAN switch 2110 allows for each LRU node connected to the Ethernet to be treated as a single segment, and faster data transfer through the Ethernet results. Multiple LAN switches 2110 are used in another embodiment of the system 1000. The present invention operates according to an appropriate networking communication standard, such as Ethernet 100 Base T, 10 Base 2, 10 Base 5, 1000 Base T, 1000 Base X, or Gigabit network. In yet another embodiment, the network could instead be an Asynchronous Transfer Mode (ATM), Token Ring, or other form of network.

Area Distribution Box

The area distribution box 2150 is generally a local seat-level routing device. The area distribution box 2150 controls the distribution of signals on the network data backbone 1500 and the RF backbone 1600 to a group of the seat electronics boxes 2160 (FIG. 2b). The area distribution box 2150 maintains assigned network addresses of seat electronics boxes 2160 and, optionally, tapping units 2130. The area distribution box 2150 preferably also includes built-in test equipment (BITE) capabilities. Additionally, the area distribution box 2150 controls and communicates with a corresponding zone passenger service system 2155 that includes, for example, overhead reading lights and attendant call indicators. Optionally, the area distribution box 2150 further operates to control the tapping unit 2130 in a similar way to that described below in connection with the audio/video controller 2120. In one arrangement, the area distribution box 2150 may have hardware effective for running a network client 400, a network server 450, or both. For example, as shown in FIG. 2c, the area distribution box 2150 includes a web server 5200 as a network server 450, which is capable of running a network server program 500 (such as a CGI script), which may control a function associated with the area distribution box 2150 within the IFES 1000, such as control of: an in-seat power supply, an overhead reading light, interactive game playing, access to the Internet, an audio or video cabin announcement system, a display of passenger flight information, an in-seat telephone or other features as described in more detail below.

The hardware of the area distribution box 2150 includes one or more microprocessors with a memory, such as a flash memory, a network interface card, an RS485 interface, and radio frequency amplifiers. Additionally, the area distribution box 2150 can contains appropriate gain control circuitry for gain control of the RF distribution 1600. The software running or stored on the area distribution box 2150 might include multiple software components, such as an operating system (e.g., LINUX), a web server (e.g., APACHE TOMCAT), TCP/IP, FTP client, FTP server, and ports or connectors for interfacing with the tapping unit(s) and CSS. An appropriate interface includes a serial port, such as RS485 interface, or a USB. As will be recognized by those of skill in the art, the area distribution box 2150 is capable of running a network client 400, a network server 450, or both depending on the hardware resources available.

Audio Video Controller

The audio/video controller 2120 generally operates as an entertainment head-end controller. The audio/video controller 2120 communicates with a plurality of input signal devices, such as cameras, video players, and audio players as discussed in more detail below. The audio/video controller 2120 is in communication with both the data backbone 1500 and the broadcast backbone 1600. The functions controlled by the audio/video controller 2120 include, for example, distributing audio and video content, controlling the tapping units 2130 and overhead display units 2140, and frequency modulation for various inputs such as video tape reproducer 2080 and audio reproducer unit 2090. As shown in FIG. 2c, the audio/video controller 2120 has a network server 450 in the form of a web server 5200, which is capable of running network server programs 500 (see FIG. 1a), such as CGI scripts, for controlling functions associated with the audio/video controller 2120 within the IFES 1000, such as control of a radio-frequency broadcast of audio or video, an in-seat audio or video stream (for example, of digital media), interactive game playing, access to the Internet, a flight-attendant call system, a surveillance system, a cabin audio or video announcement system, or a display of passenger flight information as discussed in more detail below.

Additionally, the audio/video controller 2120 can operate as a head-end controller of the passenger service system 2060 (PSS), which includes, for example, the public address system and warning indicators instructing passengers to fasten seat belts or not to smoke. Accordingly, the audio/video controller 2120 is connected to PSS related inputs such as the cockpit area microphone 2070, which can interrupt other signals over the RF backbone 1600 for crew announcements. By incorporating PSS control functions into the audio/video controller 2120, the need for a separate LRU for controlling the PSS functions is eliminated.

Furthermore, the audio/video controller 2120 operates the passenger flight information system (PFIS) 2100 as a point of access for system data, including data obtained from non-IFES equipment, such as aircraft identification, current time, flight mode, flight number, latitude, longitude, and airspeed. To facilitate external communications, the audio/video controller 2120 is further in communication with a cabin telecom unit 2050 that can communicate with earth or satellite based communication stations through one or more satellite links 2020.

As would be recognized by those of skill in the art, embodiments of the audio/video controller 2120 are capable of running a network client 400, a network server 450, or both, depending on the hardware resources available. Any LRU with hardware capable of running a network client 400 or a network server 450 may be loaded with them, as necessary for controlling a function associated with the audio/video controller 2120 within the IFES 1000.

The audio/video controller 2120 hardware includes a microprocessor, an Ethernet switch, telephony interface components, an Aeronautical Radio, Inc. (ARINC) interface, an RS485 interface, and audio modulators for the public address and audio/video content distribution. The audio/video controller 2120 contains various software components including, for example, an operating system such as LINUX, a web server such as APACHE TOMCAT, TCP/IP clients or servers such as FTP clients or servers, RS485 interfaces to the tapping units and CSS, and LAPD communications.

Digital Server Unit

The digital server unit 2500 provides analog and video outputs derived from digital content stored, for example, on a hard disk drive, and is constructed modularly with a well-defined external interface. A rack mount is provided with electrical and physical interfaces as specified in ARINC 600 (an aircraft manufacturer promulgated standard). The digital server unit 2500 obtains power, connects to external control interfaces, provides 6 base-band video outputs with 2 stereo audio outputs associated with each video output and 12 stereo outputs and 1 RF output that combines 3 RF inputs with 6 modulated video signals (including 12 stereo video-audio) and 12 stereo modulated audio outputs at this connector. Auxiliary front mounted connectors are also provided for diagnostic access and expansion of the storage sub system via a SCSI II interface.

The digital server unit 2500 provides video entertainment in a way similar to a videotape reproducer 2080 or audio tape reproducer 2090. Instead of videotape, video content is stored in compressed format, compliant with the Motion Picture Expert Group (MPEG) format (MPEG-1 or MPEG-2). The video data is stored in multiplexed format including video and between one and sixteen audio tracks in the MPEG-2 transport stream format. The audio content is stored, instead of with audio tape, on a hard disk in compressed format, compliant with the MPEG-3 (MP3) format. The high performance disk drive is accessed via a wide and fast SCSI interface by the CPU on the controller. The digital content is then streamed via TCP/IP to client platforms on circuit cards within the digital server unit 2500.

Two types of clients are implemented: video clients (two per circuit card) and audio clients (four per card). Each video client can generate one video output with two associated simultaneous stereo language tracks selected from up to sixteen language tracks multiplexed with the video. Each audio client can generate 3 or 4 audio outputs. The digital server unit 2500 contains three video client cards for a total of six video clients and six associated dual stereo video and audio/video outputs. Twelve of the audio outputs are general purpose in nature, while the 13th and 14th outputs are used to implement PRAM and BGM functions. As these two aircraft interfaces are generally monaural, MP3 programming for the 13th and 14th audio outputs is encoded and stored as monaural MP3, and only the left channel of the stereo decoder is connected to the appropriate aircraft public address system input.

The video clients are not only digital MPEG audio/video decoders, but are also general purpose PC compatible platforms, and may implement customized functions that are displayed as broadcast video channels through the broadcast backbone 1600. A typical example of this use of a video client is the implementation of a Passenger Flight Information System (PFIS) 2100.

As will be recognized by those of skill in the art, the digital server unit 2500 is capable of running a network client 400, a network server 450, or both depending on the hardware resources available. In particular, as shown in FIG. 2c, the digital server unit 2500 is useful for running a network server program 500, such as a CGI script, which is useful for controlling functions of the IFES 1000 associated with: an in-seat audio or video stream (of digital content), a radio-frequency audio or video broadcast, interactive game playing, access to the Internet or to information stored from the Internet on the digital server unit 2500 hard disk, a surveillance system, a cabin audio or video announcement system, or a display of passenger flight information.

Satellite Link

To communicate with people outside the aircraft, the IFES 1000 includes an optional satellite link 2020 in FIG. 2a, which can provide additional sources of audio, video, voice, and data content to the IFES 1000. In connection with a multi-channel receiver module 2030, it provides a plurality of video channels to the IFES 1000. The multi-channel receiver module 2030 can be connected to the RF backbone 1600 that connects to other LRUs within the IFES. The satellite link 2020 may also provide Internet access in combination with a network storage unit 2040, wherein a plurality of popular web pages are downloaded to the network storage unit 2040 while the aircraft is on the ground, when the satellite link bandwidth is not consumed with bandwidth intensive graphics or movies. In cooperation with the cabin telecommunications unit 2050, the satellite link 2020 may also provide access to ground-based telephone networks, such as the North American Telephone System (NATS). The satellite link 2020, and the network storage unit 2040, are capable of running a network client 400, a network server 450, or both.

Tapping Unit

Generally, the tapping unit 2130 is an addressable device for tapping the broadcast signal and distributing selectable or predetermined portions of the signal to one or more display units. Accordingly, the tapping unit 2130 is connected directly to one or more overhead display units 2140 mounted for viewing by a single passenger or by a group of passengers. The overhead display unit 2140 may be mounted, for example, to a bulkhead or ceiling in an overhead position, in the back of a seat in front of a viewer, an adjustable mounting structure, or in any appropriate location. In an embodiment, the IFES 1000 includes multiple tapping units 2130. The tapping unit functions to turn the display unit on or off, and to tune the tuner for audio or video channel selection. In an embodiment, the tapping unit 2130 is also used to report the status of the radio RF signal on the audio/video RF backbone 1600. In the embodiment shown in FIG. 2c, the tapping unit 2130 does not have a network client 400 or a network server 450. However, the tapping unit 2130 may have one or both of these software components, as will be recognized by those of skill in the art.

Seat Electronics Box

In FIG. 2b, which is a continuation of the block diagram of FIG. 2a, there is shown a plurality of seat electronics boxes 2160, connected to the area distribution boxes 2150 through the network data backbone 1500. Each of the seat electronics boxes 2160 provides an interface with individual passenger control units 2220, personal digital gateways 2230, video display units 2170, or smart video display units 2175 available to the respective passengers on the aircraft. In another arrangement (not shown in FIG. 2b), more than one video display unit 2170 or passenger control unit 2220 are connected to each seat electronics box 2160. The seat electronics boxes 2160 also control the power to video display units 2170, the audio and video channel selection, and volume. One or more universal serial buses 2180 or audio jacks 2200 are also connected to the seat electronics boxes 2160, allowing a passenger to connect a laptop computer 2190 or headphones 2210 into the network 1000. Hardware on a seat electronics box 2160 includes (in an embodiment) a microprocessor, RF tap, RF amplifier, RF level detection, RF gain control, and RF splitter, an FM tuner, and a digital signal processor (DSP) for handling voice over IP. In the arrangements of the system shown in FIGS. 1a and 1b, the LRU A 100, LRU B 125, and LRU C 150 might be seat electronics boxes 2160, although it is not necessary to the method of the present invention (as described above) for the LRUs shown to be seat electronics boxes 2160. As would be recognized by those of skill in the art, the seat electronics box 2160 is capable of running a network client 400, a network server 450, or both depending on the hardware resources available. A network server program 500 running on a network server 450 on a seat electronics box 2160 can be used to control functions of the IFES 1000 associated with: an in-seat power supply, an overhead reading light, a climate adjustment system, a seat adjustment system (including, for example, control of one or more motors used for moving the seat), or an in-seat telephone.

As indicated in FIG. 2c, the seat electronics box 2160 can have both a network client 400 (in the form of a virtual web browser 5150), and a network server 450 (in the form of a web server 5200). Alternatively, a different set of software components may be loaded onto the seat electronics box 2160, as will be recognized by those of skill in the art.

Features according to the embodiments of the present invention that can be employed in and achieved by the IFES 1000 discussed above will now be described.

As discussed briefly above, the vehicle, such as an aircraft, in which the IFES 1000 is employed has various sensors, components and the like that provide a significant amount of information relating to the state of the aircraft. The audio/video controller 2120 can receive this information from one if its various inputs as discussed above and can use this information to provide triggers for airline desired presentations, such as safety information to be presented during takeoff, landing, turbulence, and so on.

Many of these triggers can be used by entertainment features not related to PFIS. These triggers can be provided by a variety of interfaces such as discrete keylines, ARINC 429 messages, GPS systems, ARINC 485 interfaces, and others, which provide the various inputs to the audio/video controller 2120. A trigger can, for example, provide what is known as “City Pair Information” to assist in language selection, destination related advertising, general destination airport information, flight specific information and so on. That is, once the information concerning the name of the destination is received by the audio/video controller 2120, the audio/video controller 2120 can retrieve information relating to that destination from, for example, the digital server unit 2500 (see FIG. 2c), and control the display units 600 or 650 (see FIGS. 1a and 1b) to present that information in multimedia format to the passengers. This information can also be presented on 2140 but for purposes of discussion, this description will refer to display units 600 and 650 which are located at each passenger seat, and each passenger can interact with his or her respective display unit.

Another trigger can be a “Doors Closed” trigger which can be used by the audio/video controller 2120 to trigger special messages such as “Cell Phones Should Be Turned Off”, “Please Pay Attention to the Safety Briefing”, and so on. A “Weight On Wheels” trigger indicates when the aircraft has left the ground. The audio/video controller 2120 can use this input information to trigger the display units 600 or 650 to present information such as speed, altitude, or other information which is not of much use on the ground. This trigger also represents the actual time of take-off and should be used by the IFES 1000 in any flight time calculations. The “Fasten Seat Belt” trigger indicates when the flight crew has activated the fasten seat belt signs, and hence, the audio/video controller 2120 can use this input information to control the display units 600 or 650 to supplement the signs with a “Please Fasten Your Seat Belt” graphic message.

Position information, such as latitude, longitude, altitude, heading, pitch, and yaw, is used by the audio/video controller 2120 to identify the location of the aircraft on a map that can be displayed on the display units 600 or 650. This information also can be used by the audio/video controller 2120 to trigger events such as special messages, special maps, or other location related information to be presented in multimedia format by the display units 600 or 650. This information is also used to implement the landscape camera image enhancement which is discussed in more detail below. Flight Phase Information from the aircraft systems can be used by the audio/video controller 2120 to enhance a variety of aspects of the map or information presentation being generated by the display units 600 or 650. These enhancements include the types of images that are to be presented, the times when images are to be presented, and so on.

That is, in addition to information about the current location of the aircraft and the flight path, additional information appropriate to each phase of the flight should be presented. For example, at the start of the flight, the audio/video controller 2120 can control the display units 600 or 650 to generate greetings such as “welcome aboard”, information relating to the aircraft, features available on the aircraft, operating instructions, or any other information which would be useful to the passenger at the beginning of the flight. During the flight, the audio/video controller 2120 should support the generation of display information about current activities such as meal service, duty free sales, audio program description or video program operation. Toward the end of the flight, the audio/video controller 2120 could control the display units 600 or 650 to provide information about the destination airport, baggage claim, customs and immigration, connecting flights and gates. The IFES 1000 and, in particular, the audio/video controller 2120 should use the various interfaces defined to be as automatic as possible, but it should also support the manual entry of information for display by the crew.

For example, External Message Requests can be activated by a trigger by an event or input from cabin or flight crew to the audio/video controller 2120 to provide the ability to have a variety of airline messages such as “Duty Free Shop is Open” or other fixed (pre formatted) and free-form (crew entered) messages generated by the display units 600 or 650. In addition, as discussed above, the PFIS 1000 is capable of receiving information from a variety of aircraft interfaces such as the Flight Management Computer, Maintenance Computer, ACARS, Cabin Telephone Unit, and so on, and can also monitor information on busses such as the cabin printer data bus. This information can be used by the audio/video controller 2120 to cause the display units 600 or 650 to generate additional informational displays for the passengers as well as to assist in collecting maintenance information. The audio/video controller 2120 can also obtain information on flights and gates from data interfaces such as ACARS or the printer. As off-aircraft communications are enhanced, the audio/video controller 2120 can obtain information through data services such as E-mail and SMS Messaging.

Concerning the map display generated by the audio/video controller 2120, it should be further noted that although a colorized topographically view is typically displayed by the display units 600 or 650, many other types and styles of images can be generated. For example, the audio/video controller 2120 can retrieve information from, for example, the digital server unit 2500 or other sources such as a satellite, to include roadway images, satellite photo images, historical perspective images (for example, the current image contrasted with a 1900 AD view, a 1861 AD view or perhaps a futuristic view), horizon view images, and so on. In addition, the IFES 1000 should support both static images as well as images created dynamically during the flight, and a variety of different projections should be available to present the aircraft position in an entertaining and informative way.

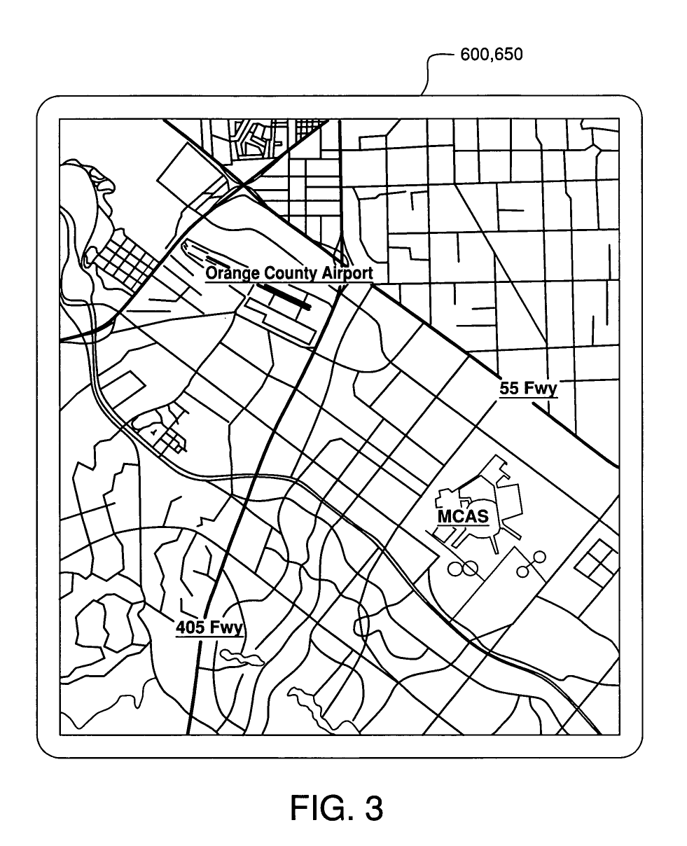

For example, one or more landscape cameras can be mounted to the aircraft to take images of the landscape while the aircraft is in flight. The real-time or frame-by-frame images (e.g., one every several seconds) taken by the landscape camera or cameras can be input to the audio/video controller 2120, for example, and thus integrated with the IFES 1000. The audio/video controller 2120 can use the aircraft position information in conjunction with the images taken by the landscape camera or cameras, such as video or still JPEG images, to generate landscape images having, for example, distance information and points of interest overlayed on the landscape image, as well as URLs or links, as shown in FIG. 3. The passenger can use his or her user interface 200 (see FIGS. 1a and 1b) to request the IFES 1000 to display these images on his or her respective display screen 600 or 650, and can use this interface to interact with the images being display, such as to select a link or URL, as discussed in more detail below. The user interface 200 can further be used to manipulate the image being displayed on the respective display screen 600 or 650, such as increasing the size of the image by a zoom-in function or decreasing the size of the image by a zoom-out function, allowing for multiple zoom levels, or by centering different portions of the image on the display screen 600 or 650, as well as any other type of image manipulating function as can be appreciated by one skilled in the art. It is also noted that as a practical matter, the IFES 1000 and camera are employed on an aircraft so that the camera can retrieve the landscape images. However, the term “in-flight” is not limited to aircraft applications, but rather, can refer to any vehicle such as a train, bus, ship and so on, in which such technology could provide enhanced passenger enjoyment.

It is further noted that as can be appreciated by one skilled in the art, the operation of the audio/video controller 2120 in conjunction with the digital server unit 2500 to create the map images from information stored on the digital server unit 2500 as they are presented is commonly called a “thick client” approach with significant processing being performed in the client, that is, the network client 400 portion of the audio/video controller 2120. However, a web server/browser approach commonly called a “thin client approach” can also be used for an interactive IFES. This will permit the broadcast product to utilize the same images as provided for iPFIS. The video client, for example, client 400, will run a browser and launch page containing javascript to force periodic requests to be made to the server, for example, 2500. The 2500 server will create the pages and provide the appropriate “next page” for each server request. This capability can, for example, enable the display units 600 or 650 to display on the landscape image a link to a web site that includes information about a point of interest on the landscape image. The web site information can be stored on the aircraft on the IFES, or can be provided via a broadband terrestrial or satellite-based Internet communication link from outside the aircraft. For instance, if the aircraft is flying over the Grand Canyon, the display unit 600 or 650 can display a link to a web site that has information pertaining to the Grand Canyon that the passenger can click on to open a window on the display which would display that information. As shown in FIG. 3, in particular, this image includes indicia links to information pertaining to the Orange County Airport, Freeways 55 and 405, and the MCAS.

It can be appreciated from the above description that as the aircraft is moving, the IFES will continuously update the image and indicia and link information displayed on the display units 600 and 650. As discussed above, the image can be in the form of a continuous moving image, or a series of still images that are updated at fixed intervals (e.g., every 5 seconds or at any other suitable interval). The IFES also updates the indicia and link information accordingly with the updates to the displayed images, so that the relevant indicia and information corresponding to the images being displayed is superimposed or otherwise integrated with or overlayed on the displayed image.

While this invention has been particularly shown and described with reference to preferred embodiments thereof, the preferred embodiments described above are merely illustrative and are not intended to limit the scope of the invention. It will be understood by those skilled in the art that various changes in form and details may be made therein without departing from the spirit and scope of the invention as defined by the appended claims.

1. An in-flight entertainment system, for use in a vehicle, comprising:
a controller, adapted to receive input data pertaining to characteristics of the vehicle and to control a display unit to generate a display image including information based on the input data, and being further adapted to receive video data provided by a camera positioned to obtain images from outside the vehicle and to control the display unit to include in the display image a video image based on the video data.

2. An in-flight entertainment system as claimed in claim 1, wherein:
the vehicle is an aircraft and the camera is positioned to obtain a landscape image from outside the aircraft while the aircraft is in flight; and
the controller is adapted to control the display unit to generate the display image which includes the landscape image and the information based on the input data pertaining to a location of the aircraft in relation to the landscape image.

3. An in-flight entertainment system as claimed in claim 1, wherein:
the vehicle is an aircraft and the camera is positioned to obtain a landscape image from outside the aircraft while the aircraft is in flight; and
the controller is adapted to control the display unit to generate the display image which includes the landscape image and the information based on the input data pertaining to a map representing points of interest for display on the landscape image.

4. An in-flight entertainment system as claimed in claim 1, wherein:
the video data is real-time video data.

5. An in-flight entertainment system as claimed in claim 1, wherein:
the video data is frame image data taken at periodic intervals.

6. An in-flight entertainment system as claimed in claim 1, wherein:
the controller is further adapted to control the display unit to include in the display image information pertaining to points of interest on the video image.

7. An in-flight entertainment system as claimed in claim 1, wherein:
the controller is further adapted to control the display unit to include in the display image information pertaining to a web site that includes information pertaining to a point of interest on the video image.

8. An image display system, adapted for use with an in-flight entertainment system (IFES), the image display system comprising:
a video display, adapted to receive video data provided by a camera positioned to obtain images from outside the vehicle, and being further adapted to receive information data from the IFES;
the video display operating to display an image including the video data and the information data on the displayed image.

9. An image display system as claimed in claim 8, wherein:
the video display is further adapted to display the video data as a map having the information data represented as indicia on the map.

10. An image display system as claimed in claim 9, wherein:
the indicia is presented as sets of respective indicia at respective locations on the map proximate to respective images on the map relating to the information represented by the respective sets of indicia.

11. An image display system as claimed in claim 10, wherein:
at least one of the respective indicia includes a link to additional information stored at a location other than the video display.

12. An image display system as claimed in claim 11, wherein:
the other location is a storage location in the IFES or a storage location remote from the vehicle, such that the additional information is provided to the video display via a wireless communication link.

13. An image display system as claimed in claim 8, wherein:
the image is a static image.

14. An image display system as claimed in claim 13, wherein:
the video display updates the static image based on video data provided by the camera at intervals in time.

15. An image display system as claimed in claim 8, wherein:
the image is a moving picture type image.

16. An image display system as claimed in claim 8, wherein:
the image is a JPEG image.

17. An image display system as claimed in claim 8, further comprising:
an interactive device, adapted to enable a user to interact with the video display to allow the user to control the image being displayed by the video display.

18. An image display system as claimed in claim 17, wherein:
the interactive device enables the user to cause the video display to change the magnitude of the image being displayed.

19. An image display system as claimed in claim 11, further comprising:
an interactive device, adapted to enable a user to interact with the video display to allow the user to select the link to cause the video display to display the additional information.

20. An image display system as claimed in claim 19, wherein:
the selected link causes the video display to retrieve the additional information via an Internet based device remote from the vehicle.
